(19) United States
(12) Patent Application Publication
(10) Pub. No.: US 2008/0141013 A1
(43) Pub. Date: Jun. 12, 2008

(54) DIGITAL PROCESSOR WITH CONTROL MEANS FOR THE EXECUTION OF NESTED LOOPS

(75) Inventors: Robert Klima, Vienna (AT); Alois Hahn, Vienna (AT)

Correspondence Address: SCHNECK & SCHNECK, P.O. BOX 2-E, SAN JOSE, CA, 95109-0005, US

(73) Assignee: ON DEMAND MICROELECTRONICS, Vienna (AT)

(21) Appl. No.: 11/923,984

(22) Filed: Oct. 25, 2007

Related U.S. Application Data
(60) Provisional application No. 60/862,776, filed on Oct. 25, 2006.

(51) Int. Cl. G06F 9/30; G06F 9/32

(52) U.S. Cl. 712/241; 712/E09.078

(57) ABSTRACT

A method and apparatus to control execution of nested loops is disclosed. The method and apparatus stores the loop level of a current loop in execution and uses this loop level to manage a data set provided for each loop. The data set for each loop includes a start address, an end address, and a loop counter or a loop flag, respectively. The method and apparatus allows arbitrary nested loops to be controlled without increasing a complexity level of the circuit and allows additional loop control. The only precondition is that the loop end addresses are different.

### CROSS-REFERENCE TO RELATED APPLICATION

This application claims priority from U.S. Provisional Patent Application Ser. No. 60/862,776 entitled “Digital Processor with Control Means for the Execution of Nested Loops” filed Oct. 25, 2006 which is hereby incorporated by reference in its entirety.

### TECHNICAL FIELD

The present invention relates generally to microprocessors, and in particular to a computer utilizing a zero overhead loop strategy for an arbitrary number of nested loops.

### BACKGROUND

Many different processor architectures are known in the art. Known processors typically read instructions and data, perform operations on the data according to the instructions, and forward results from the operations to other stages. FIG. 1 shows in simplified form an instruction flow in a typical prior art processor. Instructions are read from a program memory 55 and are stored in an instruction register 57. The instruction stored in the instruction register 57 is then decoded by a decoder logic 59 which expands the instruction to a series of control signals and digital values to support and select succeeding elements such as arithmetic logic units (ALUs), multiplexers, or memories. A decoder stage, which includes the decoder logic 59 and a decode register 61, stores a broad instruction in the decode register 61 which is used by an execute stage 63. The execute stage 63 includes one or more processing elements (not shown explicitly) which perform operations on data according to the broad instruction stored in the decode register 61. The broad instruction can comprise control signals and values.

According to the example shown in FIG. 1, when one instruction is executed in the execute stage 63, a subsequent instruction is decoded by the decode logic 59 and the next subsequent instruction is fetched from the program memory 55. This approach allows a processor to fetch, decode, and execute instructions in a pipeline and, therefore, is called an instruction pipeline. As the instructions flow through the instruction pipeline, the flow of instructions is often termed an instruction stream. Many processor architectures available today modify the instruction pipeline by modifying the stages or by introducing new stages (not shown). However, the concept remains the same.

Jumps, conditional jumps, and loops are exceptional events in an instruction stream and cause instruction streams to stall. As a consequence, processing units run idle if no additional effort to fill the pipes is made. This phenomena is caused when, e.g., counters are compared with a value or conditions are evaluated in the execute stage 63. As a consequence, the decode logic 59 is idle and even the instruction fetch of the next subsequent instruction from the program memory 55 cannot be performed until the condition is evaluated or a result of the comparison of a program count control unit 60 is performed.

The program count is the address of the instruction which is read from the program memory 55. The program count is stored in a program count register 51 and is modified by a program count control logic 53 which can handle jumps, conditional jumps, and even loops.

Usually, two kinds of loops are used: loops that are bound to a condition, and loops that are bound to a counter. Loops that are bound to a condition work similar to conditional jumps and cause the program count to jump back to an instruction of the instruction sequence before the current instruction in case a condition evaluates to true. Loops that are bound to a counter repeat a loop as long as a counter is not equal to zero decrementing a counter at the end of each cycle.

One technique to avoid idle stages and stalling of the instruction stream in case of loops is a zero overhead loop approach. Several implementations of zero overhead loops are available that allow a logic circuit to determine whether the loop has to be repeated or not in either the decode stage or the fetch stage. The main idea of zero overhead loops is that the loop control is located in the fetch stage (or alternatively in the decode stage) and not in the execution stage.

Nested loops traditionally require additional complex logic to implement. Available approaches limit the number of nested loops or use a high number of logic elements such as comparators or use a high number of registers.

However, even for single-instruction multiple data (SIMD) architectures, loop control is of high importance as a multitude of physical units (PUs) work in parallel. The PUs in SIMD architectures normally are controlled by a central control unit. Idle execute stages in such architectures would mean all execute stages of all PUs are running idle thus leading to a higher loss of processing power.

However, even with various techniques applied, there is still considerable room for improvement. Therefore, what is needed is a high-performance implementation of zero overhead loops which provides the loop depth, i.e., the loop level, and provides an optimal and simple circuit to control nested loops.

### SUMMARY OF THE INVENTION

A method and apparatus to control execution of nested loops is disclosed. The method and apparatus stores the loop level of the current loop in execution and uses this loop level to select the correct data set provided for each loop. This data set for each loop includes a start address, an end address, and a loop counter or a loop flag, respectively. The method and apparatus can use just one comparator and makes use of a loop level control logic and a loop control logic. Example embodiments for such a loop level control logic and a loop control logic are provided. The method and apparatus allows arbitrary nested loops to be controlled without increasing the complexity of the circuit and allows additional loop control. The only precondition is that the loop end addresses are different.

In an exemplary embodiment, the present invention is an electronic circuit to implement zero overhead loops for N nested loops in a processor. The circuit includes a program count register configured to store a program count where the program count is an address of an instruction to be fetched, a plurality of loop start registers configured to store loop start addresses of the N nested loops where the loop start addresses are addresses of a first of a plurality of instructions of the nested loops, and a plurality of loop end registers configured to store loop end addresses of the N nested loops where the loop end addresses are addresses of a last of the plurality of instructions of the nested loops. The circuit also includes a loop level control logic configured to control and set a loop level where the loop level control logic including a loop level register configured to store a loop level.

In another exemplary embodiment, the present invention is a method of controlling N nested loops including storing a program count where the program count are an address of an instruction to be fetched next, storing a set of N loop start addresses, where the loop start addresses are the addresses of a first of the instructions of the N nested loops, storing a set of N loop end addresses where the loop end addresses are the addresses of a last of the instructions of the N nested loops, and storing a loop level where the loop level are a number of a current loop with the current loop being a most inner loop containing an instruction in execution. The method also includes determining a current loop start address out of the set of N loop start addresses using the loop level, determining a current loop end address out of the set of N loop end addresses using the loop level, generating a next address by incrementing the program count, selecting a next value for the program count from a set of possible program count values, comparing the program count with the current loop end address, controlling and setting the loop level, and controlling and setting the program count multiplexer.

### BRIEF DESCRIPTION OF THE DRAWINGS

FIG. 1 shows, in simplified form, a typical instruction pipeline of processors known in the art.

FIG. 2 is an exemplary embodiment of the present invention including a processor comprising a VLIW architecture which contains an arbitrary number of parallel processing elements. A main control unit fetches and decodes instructions and controls execution of the instructions and the instruction flow in the slices arbitrary number of parallel processing elements.

FIG. 3 shows in simplified form an exemplary embodiment of the present invention managing four nested loops. The schematic architecture of the zero overhead circuit includes a loop level control logic that stores and controls a loop level. The loop level is used to control the loop control logic and the program count.

FIG. 4 shows in simplified form an exemplary instruction pipeline which has means to provide a loop level to the execute stage which is aligned to the instruction in execution.

FIG. 5 shows an exemplary execution of three nested loops in chronological order. The example also demonstrates the function of the loop control logic and the loop level control logic of FIG. 3.

FIG. 6 shows in simplified form an exemplary embodiment of the present invention. The architecture enables execution of three nested loops and shows example implementations of a loop level control logic and a loop control logic.

FIG. 7 shows in simplified form an exemplary embodiment of the present invention. The architecture is an extension to the architecture shown in FIG. 6 and contains means to reset the state of the circuit.

FIG. 8 shows in simplified form an exemplary embodiment of the present invention. The architecture enables execution of three nested loops and shows another implementation for the loop control logic where loop flags as results of evaluated loop conditions.

### DETAILED DESCRIPTION

Typical computer programs make use of nested loops. Each loop in a set of nested loops has a loop level. Imagine a number of N nested loops, where each loop except for the most outer one is contained in another loop. The loop level (LL) of the most outer loop is 1 and the LL of the most inner loop is N. Therefore, loop N is contained in loop N−1 which is contained in loop N−2 and so on. Hence, all loops are contained in loop 1. Each loop has a start address and an end address which are the bounds of a loop. Hence, every instruction contained in loop N is within the bounds of all other loops as well.

As a result of an analysis of available programs, in most of all programs nested loops have different end addresses. Given, for example, three nested loops, in most applications the end address of loop 1 is higher than the end address of loop 2 which is higher than the end address of loop 3.

Disclosed herein, the property of nested loops for which the end address of every loop is higher than the end address of its nested inner loops is termed characteristic of the disclosure. The present invention exploits this characteristic and supports nested loops which are arranged in such a way.

Hence, programs that make use of nested loops which have the same end address have to be rearranged for execution by the disclosed method and apparatus. The only criteria those loops have to meet is the characteristic of the disclosure. As those loops which exactly have the same end addresses can be easily rearranged by the programmer to meet the required characteristic, the present invention can be applied to all available programs.

The characteristic leads to a significant reduction of the complexity of a zero overhead loop circuit. One advantage of the present invention is that it can be used for an arbitrary number of nested loops without increasing the complexity of the circuit. For example, registers may be used which store loop start addresses, loop end addresses, and loop count registers to control a loop. Any associated logic can be kept very small and does not depend on the number of nested loops to be supported. To achieve this design, the present invention stores and provides the loop level (LL) of the current loop that is currently being executed. The loop level can be used for control purposes as well. Controlling the loop level enables additional loop control. For example, to skip inner loops without requiring any changes to the program is explained in detail herein. In the disclosure which follows, the loop level of the current loop will be referred to simply as the loop level.

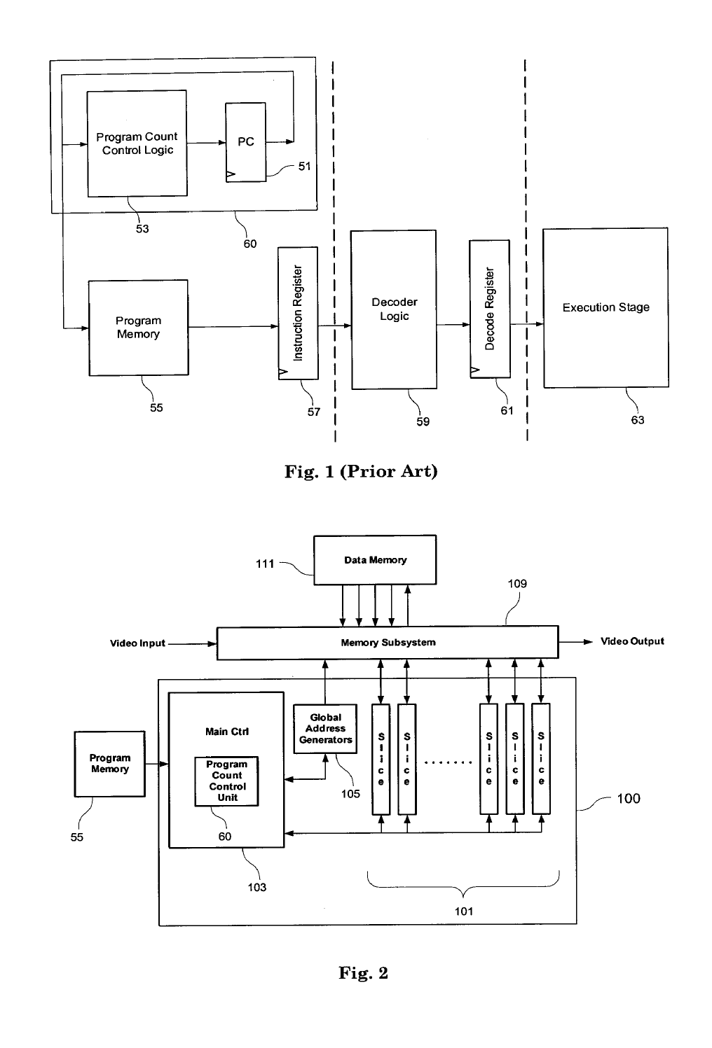

FIG. 2 shows an exemplary simplified block diagram of a processor architecture. A processor 100 comprises a main control unit 103, an address generation unit 105, a plurality of parallel processing units 101 (also known as “slices”), and several interfaces. The processor 100, in this exemplary architecture, makes use of a technique similar to the SIMD approach and uses a Harvard Architecture. Specifically, the program memory 55 and an external data memory 111 are decoupled over separate buses. However, in the prior art case shown in FIG. 1, the processor 100 is not directly connected to the external data memory 111. Instead, each of the plurality of parallel processing units 101 can read and write data from and to a memory subsystem 109 over, for example, four 20 bit read ports and one 40 bit write port. The loop control circuit of the disclosure may be part of the program count control unit 60.

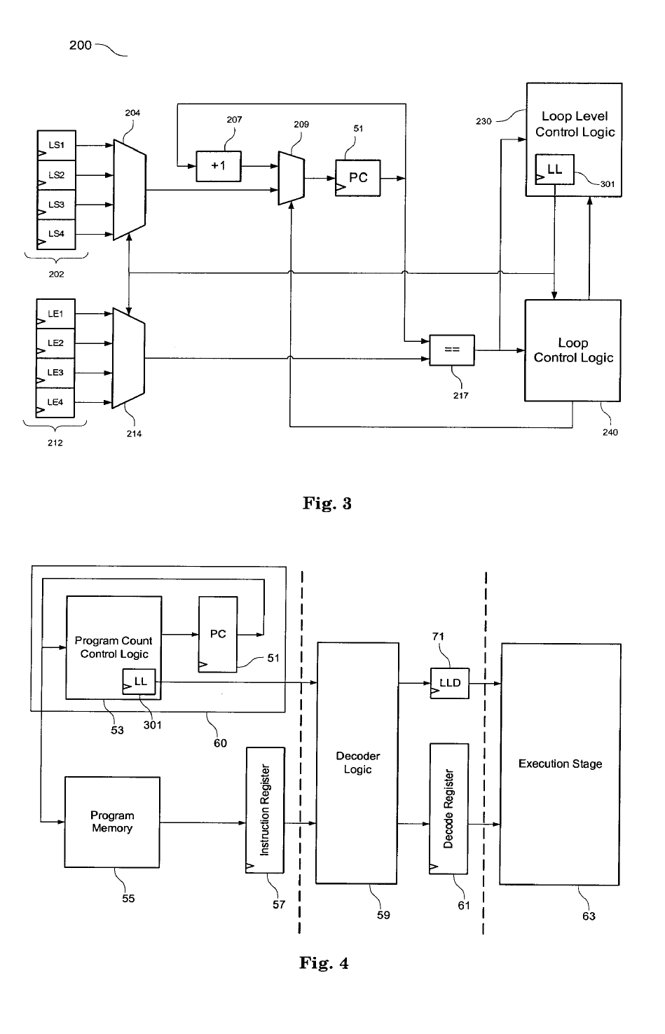

FIG. 3 shows, in simplified schematic form, an exemplary embodiment of techniques employed by the present invention. The program count (PC) is stored in the program count register 51. The PC is used to fetch a subsequent instruction from the program memory 55 as shown in FIG. 1. The exemplary embodiment as shown in FIG. 3 does not show logic to handle jumps, conditional jumps, or interrupts which are also included in the program count control unit 60 as depicted in FIG. 1. To include control of regular jumps, or conditional execution the architecture as shown in FIG. 3 may be extended. However, as this disclosure deals with zero overhead loops, those parts are not considered.

The exemplary embodiment of FIG. 3 may control four nested loops. The loops are enumerated 1, 2, 3, and 4. Each loop has a loop start (LS) address and a loop end (LE) address. LS and LE define the bounds of the loop. The loop start address LS1 of loop 1, the loop start address LS2 of loop 2, the loop start address LS3 of loop 3, and the loop start address LS4 of loop 4 are stored in a set of start registers 202. The loop end address LE1 of loop 1, the loop end address LE2 of loop 2, the loop end address LE3 of loop 3, and the loop end address LE4 of loop 4 are stored in a set of end registers 212.

A loop level (LL) register 301 stores the LL of the loop which will be repeated next. The loop which has the LL that is stored in the LL register 301 is called a current loop. As an example, imagine two nested loops: an outer loop (LL=1) and an inner loop (LL=2). When the loops are entered the first time, the LL register 301 is set to 2 as the inner loop (LL=2) is the loop that is repeated first. The LL register 301 holds the value 2 until all loop iterations of the inner loop have been performed. The LL register 301 is then set to the LL of the next outer loop, which is 1 in this example. When the end address of the outer loop (LL=1) is reached, the next loop iteration of the outer is performed, the LL register 301 is set back to the maximum LL which is 2 again and the process is repeated until all outer loop iterations are performed.

The LL register 301 is set and controlled by a loop level control logic 230. The LL is used to select the bounds of its loop by means of a start multiplexer 204 and an end multiplexer 214. The start multiplexer 204 uses the value of the LL register 301 to select the current loop start address from the loop start addresses stored in the set of start registers 202. The end multiplexer 214 uses the value of the LL register 301 to select the current loop end address from the loop end addresses stored in the set of end registers 212.

A comparator 217 signals a loop control logic 240 when the current loop end address and the PC are equal. The loop control logic 240 is responsible to decide and to signal whether the current loop has to be repeated or not. Reasons to repeat a loop can be that a certain loop condition is true or that a certain number of loop iterations have not yet been reached. If the current loop has to be repeated, the loop control logic 240 resets the PC register 51 to the start address of the current loop. The loop control logic 240 uses a PC multiplexer 209 to load the PC register 51 either with the next address calculated by an incrementer 207 or with the current loop start address received from the start multiplexer 204.

If the loop control logic 240 decides that a loop must not be repeated, the loop control logic 240 signals the loop level control logic 230 that the loop level has to be decremented. As previously mentioned, the loop level control logic 230 controls and sets the LL register 301. The loop level control logic 230 can be implemented in different ways. Embodiments of the present invention can use the LL register 301 to avoid the execution of loops. Other embodiments of the present invention can use the LL register 301 to explicitly control which loops have to be performed.

In alternative embodiments, the LL register 301 can even be read and written by the execute stage. However, the execute stage operates on instructions which have been fetched several cycles before. Therefore, from the execute stage point of view, the LL value which is stored in the LL register 301 contains the LL of the instruction which will be executed in one of the next cycles. Other embodiments of the present invention can use additional registers in the stages between the fetch stage and the execute stage to avoid such a misalignment.

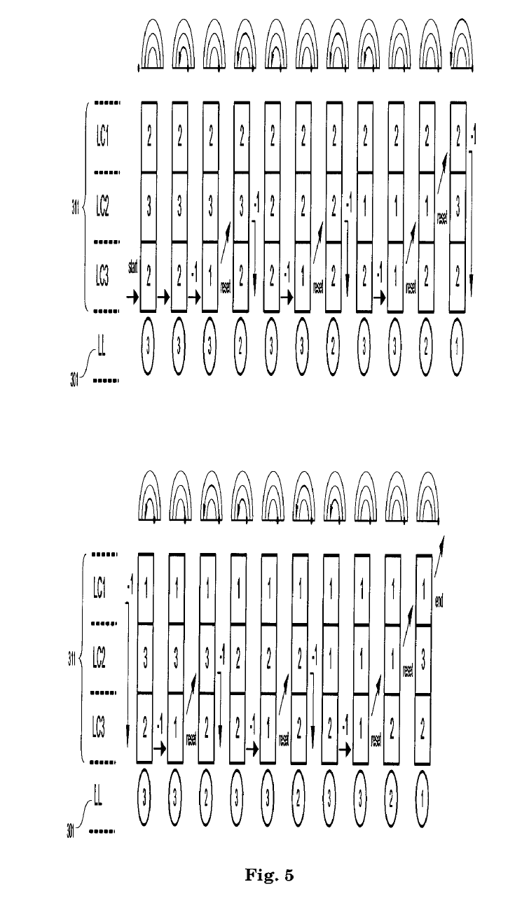

In FIG. 4, an LLD register 71 is used for this purpose: the execute stage forwards the LL to the LLD register 71 in the decoder stage. The execute stage 63 can read the aligned LL from the LLD register 71.

As an example of loop execution, FIG. 5 shows the execution of three nested loops in chronological order. FIG. 5 also demonstrates the function of the loop control logic 240 and the loop level control logic 230. FIG. 5 indicates, for several states in the loop execution, the values of loop count registers 311 and the LL register 301. The loop count registers 311 store the repeat count of the three example loops and can be handled by the loop control logic 240. The loop diagrams in FIG. 5 illustrate the nested loops where each of the three nested loops is represented by a semi circle—an outer loop semi circle, a middle loop semi circle, and an inner loop semi circle. The dot in the loop diagrams specifies the current PC. Below each loop diagram the states of the loop count registers 311 and the state of the LL register 301 are given. The loop diagram in combination with the loop count registers 311 and the LL register 301 form a loop state diagram. In this example, FIG. 5 shows 21 loop state diagrams. The transitions (arrows) between the loop state diagrams denote the LL graphically—the value of the LL is given in the circle below each loop state diagram.

The first loop state diagram shown in FIG. 5 shows initialized registers where the PC (the dot) is outside the loops. The second loop state diagram shows the PC at the end of the first loop. The loop control logic 240 decrements the inner loop counter LC3 (indicated by the −1) and initiates a second iteration of the inner loop.

After the second iteration of the inner loop the PC again is at the end of the first loop as shown in the third loop state diagram. The count LC3 is 1 and another decrement of the inner loop counter LC3 would result to zero. Therefore, the counter LC3 is reset with the loop count start value of LC3 (its loop count start value is 2) and the value in the LL register 301 is decremented to 2 which is illustrated by the arrow up. No further iteration of the inner loop is initiated.

When the PC reaches the end of the middle loop as shown in the fourth loop state diagram, the middle loop counter LC2 is decremented and the LL register 301 is set to the maximum LL, illustrated by the arrow down to the bottom. The maximum LL is 3 which is the number of nested loops that are processed. The loop control logic 240 initiates a second iteration of the middle loop.

Continuing, the ninth loop state diagram shown in FIG. 5 shows the PC again at the end of the inner loop. The inner loop has been executed. The count LC3 is 1 and another decrement of the inner loop count LC3 would result to zero. Therefore, the count LC3 is reset with the loop count start value of LC3 (2) and the value in the LL register 301 is decremented to 2 which is illustrated by an arrow up.

The next loop state diagram shown in FIG. 5 shows the PC again at the end of the middle loop. The middle loop has been executed three times, the count LC2 is one and another decrement of the middle loop count LC2 would result to zero, too. Therefore, the counter LC2 is reset with the loop count start value of LC3 (3) and the value in the LL register 301 is decremented to 1 which is illustrated by an arrow up. No further iteration is initiated.

The eleventh loop state diagram shown in FIG. 5 shows the PC at the end of the outer loop. The outer loop counter LC1 is decremented and the LL register 301 is set to the maximum LL (3) which again is illustrated by the arrow down to the bottom. The loop control logic 240 initiates a second and last iteration of the outer loop.

The last loop state diagram shown in FIG. 5 shows the PC at the end of the outer loop. The outer loop has been executed two times, the count LC1 is 1 and another decrement of the outer loop count LC1 would result to zero. Therefore, the PC is incremented and the nested loops have been processed regularly. No further iteration is initiated.

As shown in FIG. 5 the LL register is only decremented, and in some cases the LL register 301 is reset to the maximum LL. From FIG. 5 it can be easily seen, that if the LL register would be reset to a lower value (e.g., 2 instead of 3) the jumps of the inner loop would not be performed. Instead, only the loop state diagrams with a LL register value lower or equal to 2 would be executed.

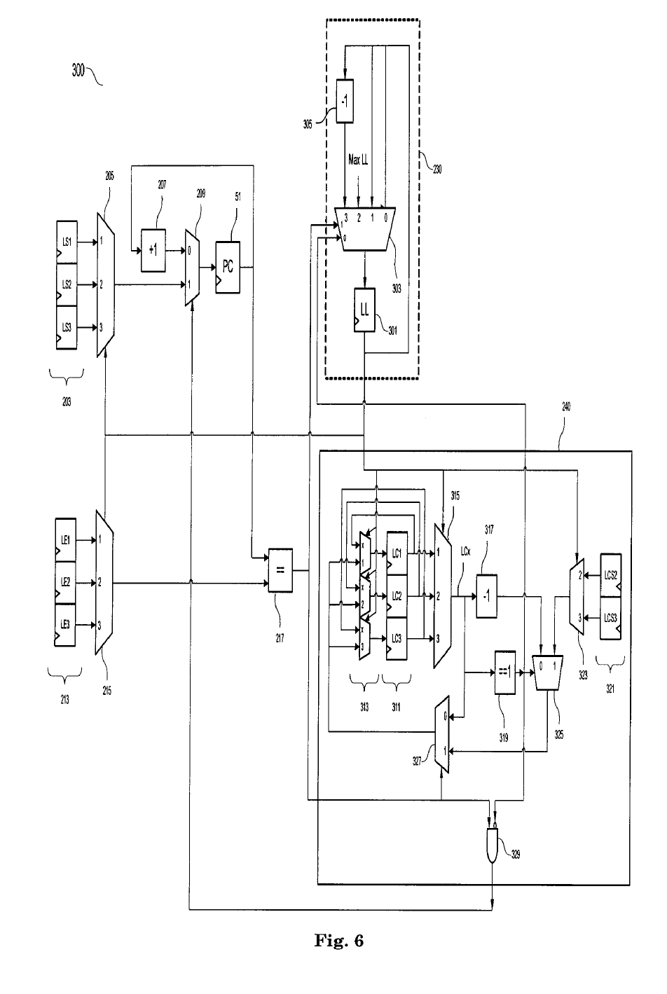

FIG. 6 shows another exemplary embodiment of a circuit 600 of the present invention with implementations for the loop level control logic 230 and the loop control logic 240. The loop control logic 240 receives the LL value stored in the LL register 301. In the embodiment of the loop control logic 240 shown in FIG. 6, the LL value is used to control a first 313, second 315, and third 323 multiplexer. The second multiplexer 315 selects the current loop count LCx from the loop count registers 311 which corresponds to the LL value stored in the LL register 301. An LCx decrementor 317 decrements the loop counter LCx. If the loop counter LCx is not equal to one, a fourth multiplexer 325 forwards the decremented loop counter LCx. Otherwise the loop count start value determined by the third multiplexer 323 to a fifth multiplexer 327. The loop count start values for all loops but the most outer loop are stored in a set of loop count registers 321. The loop count start registers 321 are used to reset the loop count of loops. As the outer loop count never has to be reset again once the loop is processed, the loop count start value of the outer loop needs not to be stored.

The comparator 217 signals the loop control logic 240 when the current loop end address and the PC are equal. This signal is used by the fifth multiplexer 327 to forward the correct loop count to the input multiplexers 313 of the loop count registers 311. The correct loop count is the value determined by the fourth multiplexer 325 in case the PC and the current loop end address are equal otherwise the loop count LCx.

The loop level control logic 230 controls and sets the LL register 301. The example implementation for the loop level control logic 230 shown in FIG. 6 includes a LL register 301, an LL multiplexer 303, and an LL decrementor 305 which decrements the LL stored in the LL register 301 and forwards the decremented value to the LL multiplexer 303. The simple logic shown in FIG. 6 for the loop level control logic 230 holds the LL when the PC and the current loop end address are not equal. However, if the PC and the current loop end address are equal the LL is modified: the LL is decremented in case the current loop count LCx is 1 which is determined by the comparator 319 or is set to a Max LL otherwise.

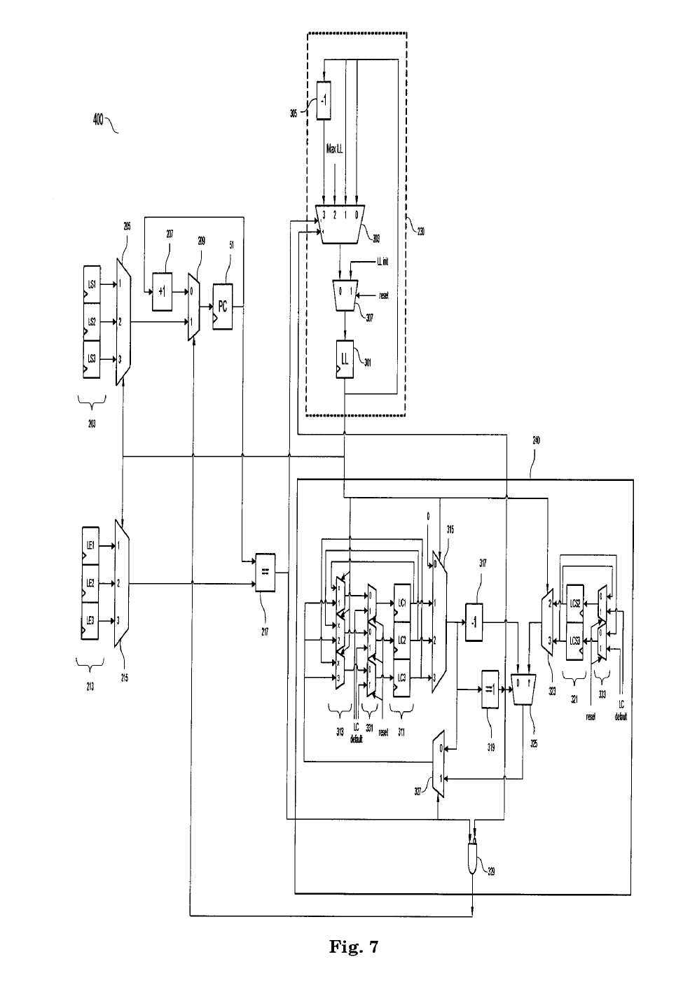

FIG. 7 shows an exemplary extension 400 to the circuit 600 discussed in FIG. 6. Modified versions of the loop level control logic 230 and the loop control logic 240 are included. The modified versions of the loop level control logic 230 and the loop control logic 240 allow an external control unit (not shown) to set the LL register 301 using an external control unit controlled multiplexer 307. The external control unit can also load the loop count registers 311 and the loop count start registers 321 using a first LC multiplexer 331 and a second LC multiplexer 333, respectively.

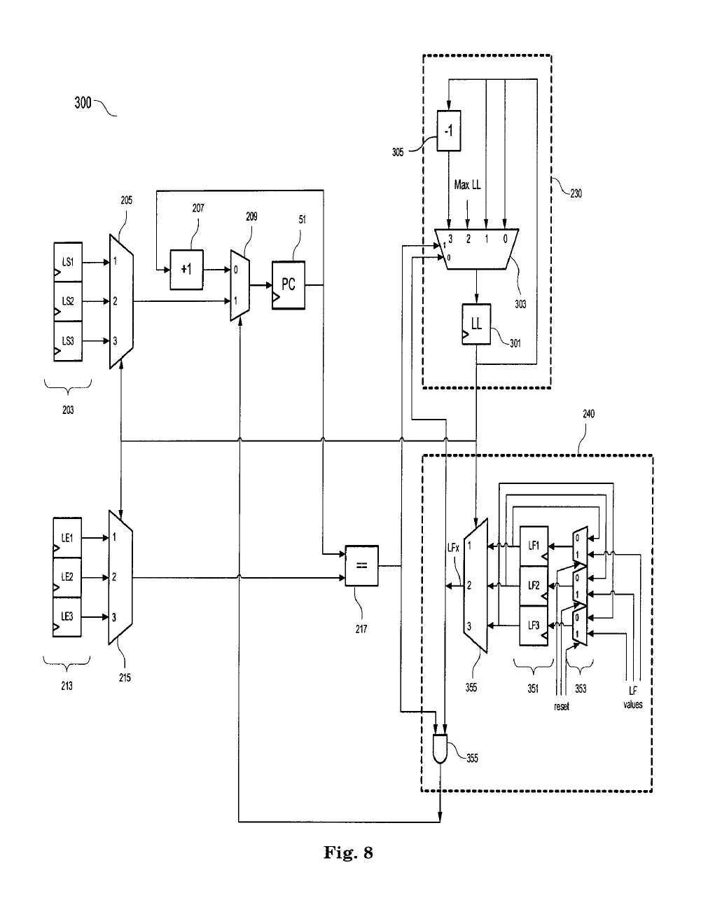

FIG. 8 shows another embodiment of the present invention. The circuit 500 shown in FIG. 8 uses a different implementation for the loop control logic 240 which does not include loop counts. Instead, for each loop a Boolean value is stored in loop flag registers 351. The LL register 301 is used to select the current loop flag LFx from the values stored in the loop flag registers 351. LF multiplexers 353 enable to hold the values stored in the loop flag registers 351 or to load new values from an external unit (not shown) from, for example, the execute stage. Therefore, the embodiment of the loop control logic 240 shown in FIG. 8 allows loop conditions to be evaluated by external ALUs. The evaluated results of the loop conditions can then be stored in the loop flag registers 351.

In the foregoing specification, the present invention has been described with reference to specific embodiments thereof. It will, however, be evident to a skilled artisan that various modifications and changes can be made thereto without departing from the broader spirit and scope of the present invention as set forth in the appended claims. For example, various embodiments described utilize registers, multiplexers, and other electronic components. A skilled artisan will recognize that other components or combinations thereof may serve similar functions and thus may be substituted for the various embodiments described herein. These and various other embodiments are all within a scope of the present invention. The specification and drawings are, accordingly, to be regarded in an illustrative rather than a restrictive sense.

What is claimed is:

1. An electronic circuit to implement zero overhead loops for N nested loops in
a processor, the circuit comprising:
a program count register configured to store a program count, the program count being an address of an instruction to be fetched;
a plurality of loop start registers configured to store loop start addresses of the N nested loops, the loop start addresses being addresses of a first of a plurality of instructions of the nested loops;
a plurality of loop end registers configured to store loop end addresses of the N nested loops, the loop end addresses being addresses of a last of the plurality of instructions of the nested loops; and
a loop level control logic configured to control and set a loop level, the loop level control logic including a loop level register configured to store a loop level.

2. The electronic circuit of claim 1, further comprising:
a loop start multiplexer coupled to the plurality of loop start registers and configured to select a current loop start address from the loop start addresses;
a loop end multiplexer coupled to the plurality of loop end registers and configured to select a current loop end address from the loop end addresses;
an incrementor configured to increment the program count from the program count register and output a next address;
a program count multiplexer coupled to the incrementor and the loop start multiplexer, the program count multiplexer configured to output a value selected from the next address when the control signal has a first control value and the current loop start address when a control signal has a second control value, the program count multiplexer further configured to load the program count register with the selected value;
a current loop end comparator configured to set a current loop end comparator signal when the program count and the current loop end address are equal, the current loop end comparator signal being applied to the loop level control logic and the loop control logic; and
a loop control logic configured to control the program count multiplexer and the loop level control logic, the loop control logic being responsive to the current loop end comparator signal.

3. The electronic circuit of claim 2 wherein the loop control logic comprises:
a plurality of N loop count registers configured to store loop counts of the N nested loops;
a plurality of N−1 loop count start registers configured to store the loop count start values of N−1 inner loops, the N−1 inner loops comprising the N nested loops excluding an most outer loop; and
a logic circuit configured to control the plurality of N loop count registers, the logic circuit further configured to decrement the value of the current loop count register when the program count and the current loop end address are equal and the current loop count is greater than one, the current loop count being the loop count of the current loop, the logic circuit using the loop count start values for restoring the loop count registers and generate a current loop count control signal when the current loop count is one.

4. The electronic circuit of claim 2 wherein the loop control logic comprises a program count control logic configured to control the program count multiplexer and generate a control signal for the program count multiplexer, the program count control logic being responsive to the current loop count control signal and the current loop end comparator signal.

5. The electronic circuit of claim 2 wherein the end address of a loop selected from the N nested loops is higher than the end address of a next inner loop.

6. The electronic circuit of claim 1 wherein the loop level control logic further includes logic configured to perform one of a set of operations on the loop level register when the program count is equal to the current loop end address and the current loop must not be repeated again.

7. The electronic circuit of claim 1 wherein the loop level register of the loop level control logic is configured to be controlled by an external control unit to read and modify the loop level register.

8. A method of controlling N nested loops, the method comprising:
storing a program count, the program count being an address of an instruction to be fetched next;
storing a set of N loop start addresses, the loop start addresses being addresses of a first of the instructions of the N nested loops;
storing a set of N loop end addresses, the loop end addresses being addresses of a last of the instructions of the N nested loops;
storing a loop level, the loop level being a number of a current loop, the current loop being a most inner loop containing an instruction in execution;
determining a current loop start address out of the set of N loop start addresses using the loop level;
determining a current loop end address out of the set of N loop end addresses using the loop level;
generating a next address by incrementing the program count;
selecting a next value for the program count from a set of possible program count values;
comparing the program count with the current loop end address;
controlling and setting the loop level; and
controlling and setting the program count multiplexer.
